(19) United States
(12) Patent Application Publication
(10) Pub. No.: US 2015/0319217 A1
(43) Pub. Date: Nov. 5, 2015

(54) Sharing Visual Media

(71) Applicant: Motorola Mobility LLC, Chicago, IL (US)

(72) Inventors: Bakak Robert Shakib, San Jose, CA (US); Andrii Gushchyk, Santa Clara, CA (US); Yuriy Musatenko, Mountain View, CA (US)

(73) Assignee: Motorola Mobility LLC, Chicago, IL (US)

(21) Appl. No.: 14/278,063

(22) Filed: May 15, 2014

Related U.S. Application Data
(60) Provisional application No. 61/986,135, filed on Apr. 30, 2014.

(51) Int. Cl. H04L 29/08; G06K 9/62; G06K 9/22; H04W 4/00; G06K 9/00

(52) U.S. Cl. CPC H04L 67/06; H04W 4/008; G06K 9/00288; G06K 9/22; G06K 9/62

(57) ABSTRACT

This document describes techniques that allow a user to quickly and easily share visual media. In some cases the techniques share visual media with an interested person automatically and without needing interaction from the user, such as to select the person or the manner in which to share an image. Further, the interested person need not be in the visual media, instead, the interested person can simply be someone that has a previously established interest in a person or object that is within the visual media.

### BACKGROUND

This application claims the benefit of U.S. Provisional Application Ser. No. 61/986,135, filed Apr. 30, 2014, the entire contents of which are hereby incorporated herein by reference in their entirety.

This background description is provided for the purpose of generally presenting the context of the disclosure. Unless otherwise indicated herein, material described in this section is neither expressly nor impliedly admitted to be prior art to the present disclosure or the appended claims.

Current techniques for sharing visual media, such as photos and video clips, can be time consuming and cumbersome. If a mother of a young child wants to share photos with the child's four grandparents and three living great-grandparents, for example, she may have to select, through various cumbersome interfaces, to share the photo and further how to share the photo for each of the seven interested grandparents and great-grandparents. Thus, one grandparent may want photos sent via text, another through email, another downloaded to a digital picture frame, and another through printed hardcopies. To share the photo to the desired people and in the desired way, the mother selects one grandparent's cell number from a contact list, enter another's email address, find another's URL from which the digital picture frame retrieves photos, and enter still another's physical address to send the printed hardcopies.

### BRIEF DESCRIPTION OF THE DRAWINGS

Techniques and apparatuses for sharing visual media are described with reference to the following drawings. The same numbers are used throughout the drawings to reference like features and components:

FIG. 1 illustrates an example environment in which techniques for sharing visual media can be implemented.

FIG. 2 illustrates a detailed example of a computing device shown in FIG. 1.

FIG. 3 illustrates example methods for sharing visual media.

FIG. 4 illustrates a photo of three friends.

FIG. 5 illustrates recognized persons and an object of the photo of FIG. 4.

FIG. 6 illustrates a recognition confirmation interface in which a user may select to confirm a recognition.

FIG. 7 illustrates an entity interface for selection or de-selection of three determined entities.

FIG. 8 illustrates lines of interest between entities and persons and/or objects.

FIG. 9 illustrates example methods for device-to-device sharing of visual media.

FIG. 10 illustrates various components of an example apparatus that can implement techniques for sharing visual media.

### DETAILED DESCRIPTION

This document describes techniques that allow a user to quickly and easily share visual media. In some cases the techniques share visual media with an interested person automatically and without needing interaction from the user, such as to select the person or the manner in which to share an image. Further, the interested person need not be in the visual media, instead, the interested person can simply be someone that has a previously established interest in a person or object that is within the visual media. For example, a video clip or photo of a grandchild can be automatically shared with the grandchild's grandmother without an explicit selection by the person taking the video or photo.

The following discussion first describes an operating environment, followed by techniques that may be employed in this environment, and proceeding with example user interfaces and apparatuses.

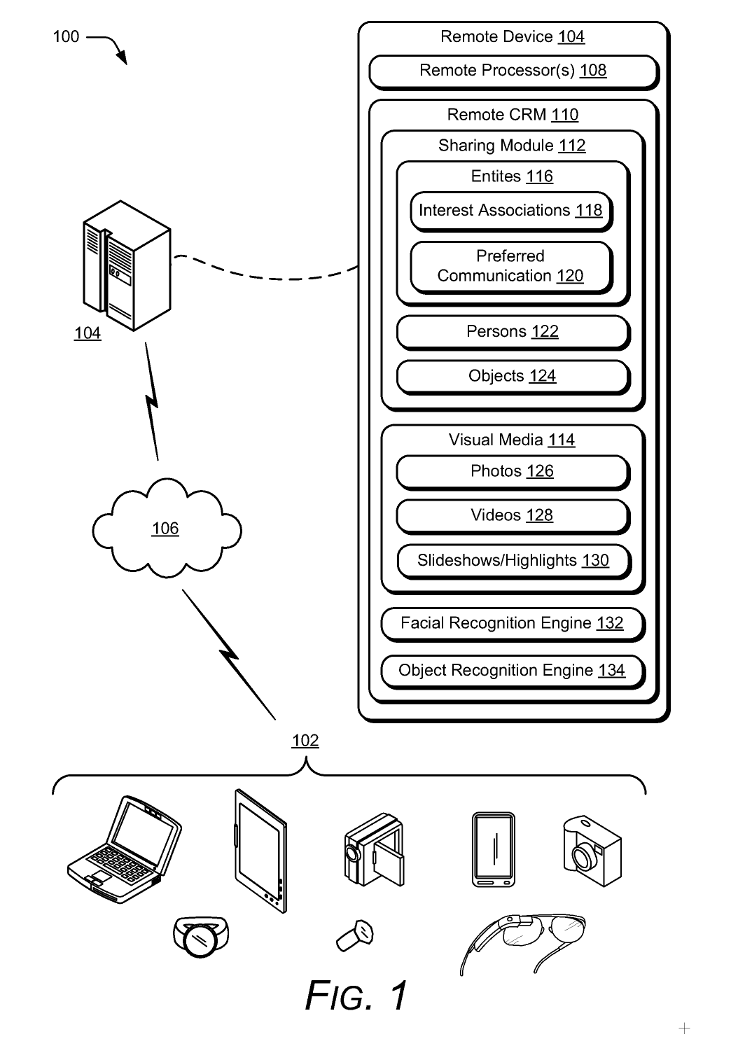

FIG. 1 illustrates an example environment 100 in which techniques for sharing visual media and other techniques related to visual media can be implemented. Environment 100 includes a computing device 102, a remote device 104, and a communications network 106. The techniques can be performed, and the apparatuses embodied on one or a combination of the illustrated devices, such as on multiple computing devices, whether remote or local. Thus, a user's smartphone may capture (e.g., take photos or video) or receive media from other devices, such as media previously uploaded by a friend from his or her laptop to remote device 104, directly from another friend's camera through near-field communication, on physical media (e.g., a DVD or Blu-ray disk), and so forth. Whether from many or only one source, the techniques are capable of sharing visual media at any of these devices.

In more detail, remote device 104 of FIG. 1 includes or has access to one or more remote processors 108 and remote computer-readable storage media (“CRM”) 110. Remote CRM 110 includes sharing module 112 and visual media 114. Sharing module 112 is capable of recognizing persons or objects within visual media, determining entities having an interest in those recognized persons or objects, and/or sharing the visual media with the determined entities, as well as other operations.

In more detail, sharing module 112 receives or determines interest associations 118 and preferred communication 120 for each of entities 116 relative to persons 122 and objects 124. Sharing module 112 can determine these interest associations 118 and preferred communications 120 based on a history of explicitly selected sharing of other visual media that also include person 122 or object 124, an explicit selection to automatically share visual media having the person 122 or object 124 (e.g., by a user or controller of the visual media), or an indication received from an entity.

Visual media 114 includes photos 126, videos 128, and slideshows/highlights 130. Videos 128 and slideshows/highlights 130 can include audio, and can also include various modifications, such as songs added to a slideshow, transitions between images or video in a highlight reel, and so forth. Other types of visual media can also be included, these are illustrated for example only.

Remote CRM 110 also includes facial recognition engine 132 and object recognition engine 134. Sharing module 112 may use these engines to recognize persons and objects (e.g., persons 122 and objects 124) within visual media 114. While these engines can recognize people and objects without assistance, in some cases prior tagging by users (e.g., a user capturing the visual media or others, local or remote) can assist the engines and improve accuracy or even supplant them and thus sharing module 112 may forgo use of these engines. Accuracy can also affect sharing, which is described further below.

As noted in part above, time-consuming and explicit selection of entities with which to share, as well as their preferred communication to received media, can be avoided by the user if he or she desires. Sharing module 112 may share automatically or responsive to selection (e.g., in an easy-to-use interface detailed below) and in other manners detailed herein.

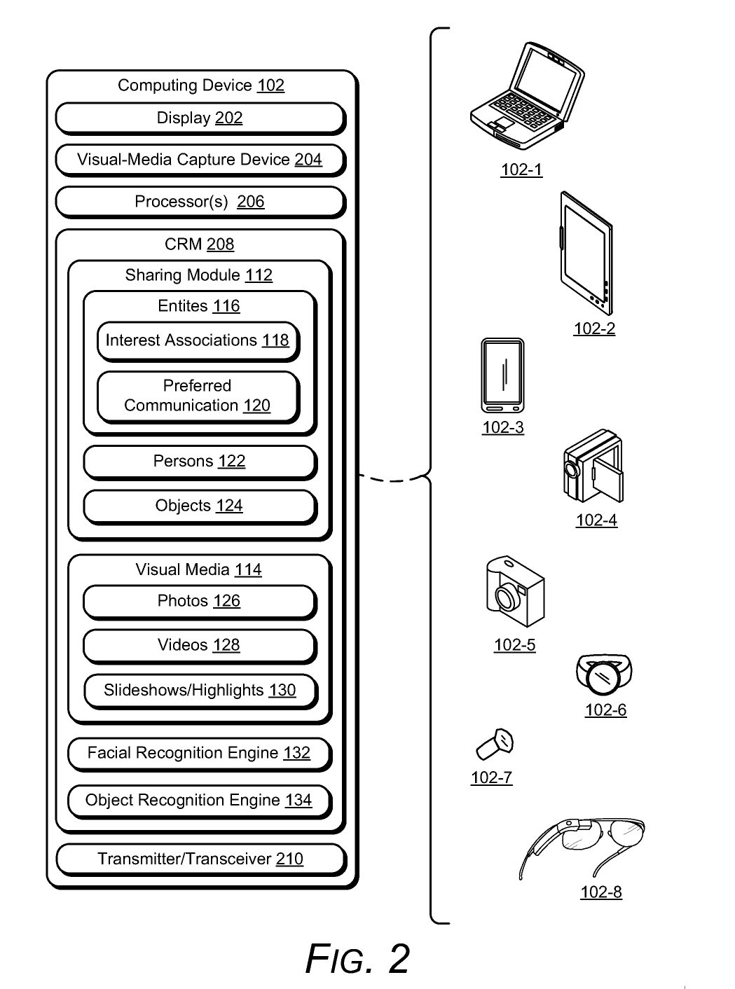

With regard to the example computing device 102 of FIG. 1. consider a detailed illustration in FIG. 2. Computing device 102 can each be one or a combination of various devices, here illustrated with eight examples: a laptop computer 102-1, a tablet computer 102-2, a smartphone 102-3, a video camera 102-4, a camera 102-5, a computing watch 102-6, a computing ring 102-7, and computing spectacles 102-8, though other computing devices and systems, such as televisions, desktop computers, netbooks, and cellular phones, may also be used. As will be noted in greater detail below, in some embodiments the techniques operate through remote device 104. In such cases, computing device 102 may forgo performing some of the computing operations relating to the techniques, and thus need not be capable of advanced computing operations.

Computing device 102 includes or is able to communicate with a display 202 (eight are shown in FIG. 2), a visual-media capture device 204 (e.g., analog or digital camera), one or more processors 206, computer-readable storage media 208 (CRM 208), and a transmitter or transceiver 210. CRM 208 includes (alone or in some combination with remote device 104) sharing module 112, visual media 114, entities 116, interest associations 118, preferred communication 120, persons 122, objects 124, photos 126, videos 128, slideshows/highlights 130, facial recognition engine 132, and object recognition engine 134. Thus, the techniques can be performed on computing device 102 with or without aid from remote device 104. Transmitter/transceiver 210 can communicate with other devices, such as remote device 104 through communication network 106, though other communication manners can also be used, such as near-field-communication or personal-area-network communication from device to device, social media sharing (e.g., Facebook™), email (e.g., Gmail™), texting to a phone (e.g., text SMS), and an online server storage (e.g., an album).

These and other capabilities, as well as ways in which entities of FIGS. 1 and 2 act and interact, are set forth in greater detail below. These entities may be further divided, combined, and so on. The environment 100 of FIG. 1 and the detailed illustration of FIG. 2 illustrate some of many possible environments capable of employing the described techniques.

Example Methods for Sharing Visual Media

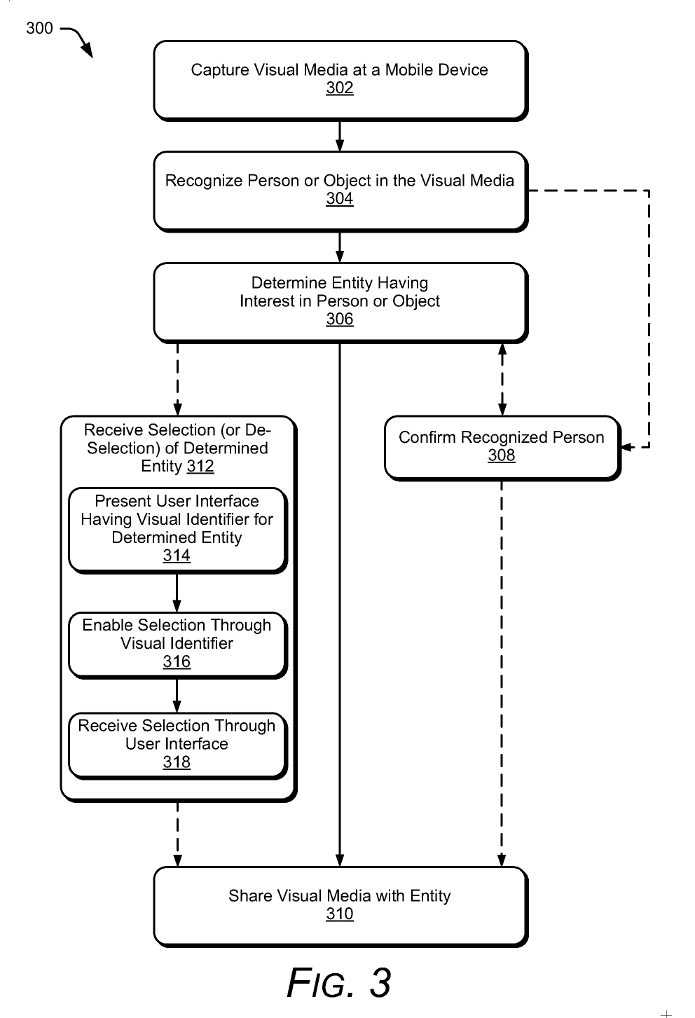

FIG. 3 illustrates example methods 300 for sharing visual media. The order in which method blocks for these and other methods described herein is not intended to be construed as a limitation, and any number or combination of the described method blocks can be combined in any order to implement a method, or an alternate method. Further, methods described can operate separately or in conjunction, in whole or in part. While some operations or examples of operations involve user interaction, many of the operations can be performed automatically and without user interaction, such as operations 304, 306, and 310.

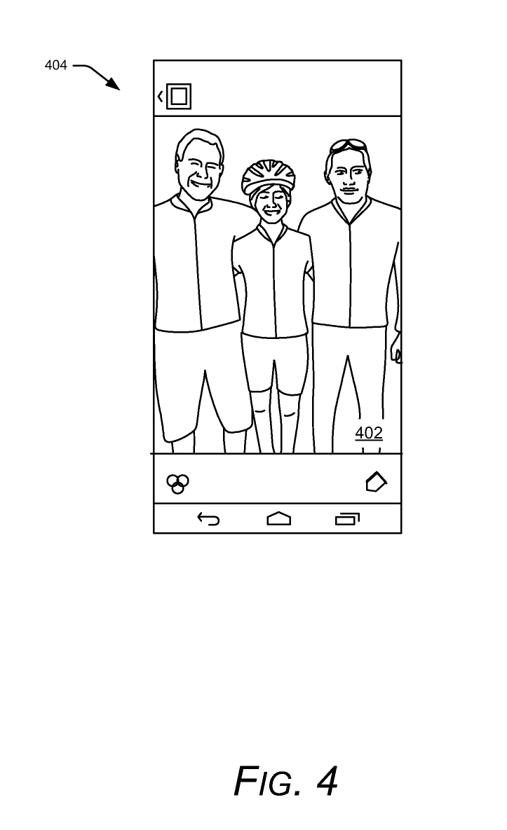

At 302, visual media is captured at a mobile computing device and through a visual-media, capture device. Thus, a user may capture a photo of herself and two friends on a bike trip through her smartphone 102-3 (shown in FIG. 2). This is illustrated in FIG. 4 with photo 402 shown in a media user interface 404 on a smartphone's display (not shown). Note that operation 302 is not required—visual media may be received from other devices or captured in other manners.

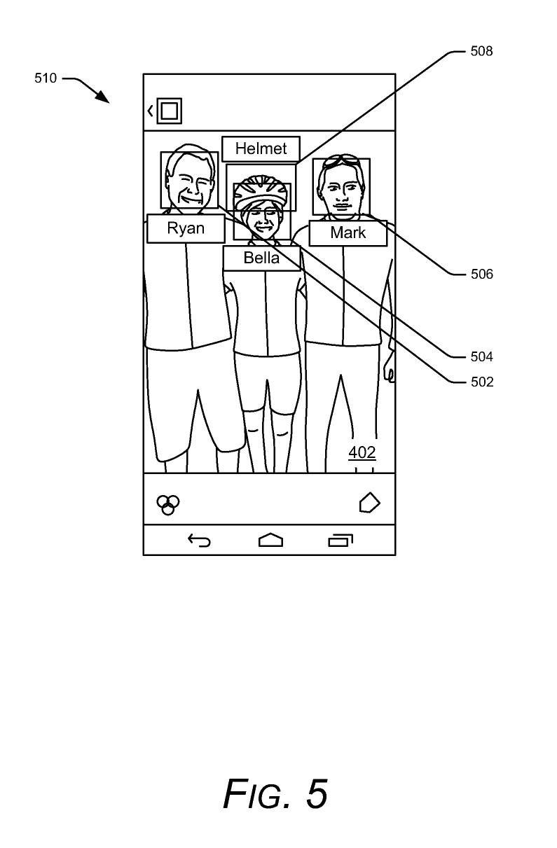

At 304, a person or object in the visual media is recognized. As noted in part above, sharing module 112 may recognize persons and objects in the captured visual media, such as by using facial recognition engine 132 and object recognition engine 134 of FIG. 2. For the ongoing example photo 402, sharing module 112 may recognize three different persons and one object, for example. These recognized persons and object are illustrated in FIG. 5, though sharing module 112 may or may not present these recognized persons and object, depending on the implementations noted below. FIG. 5 shows photo 402 of FIG. 4, along with three recognized faces, first person 502 (with text noting the person's name—“Ryan”), second person 504 (“Bella”), and third person 506 (“Mark”). The recognized object is Bella's bicycle helmet, marked as object 508 and with text (“Helmet”). These are all shown in recognition interface 510.

In some cases this recognizing can be in conjunction with, or simply selected by, a user or other entity. Thus, after operation 306 or 304 at operation 308. At 308, a recognized person is confirmed or selected. A recognized person can be recognized with a high confidence or a less-than high confidence. Sharing module 112 is capable of assigning a confidence (e.g., a probability) that a recognition is correct. This confidence can be used to determine whether or not to present a user interface enabling selection to confirm an identity of the recognized person or object prior to sharing the visual media with an interested entity (e.g., at 308). For probabilities below some threshold of confidence (e.g., 99, 95, or 90 percent), sharing module 112 may determine not to share the visual media without an explicit selection from a user, thereby attempting to avoid sending media to a person that is not interested in the media.

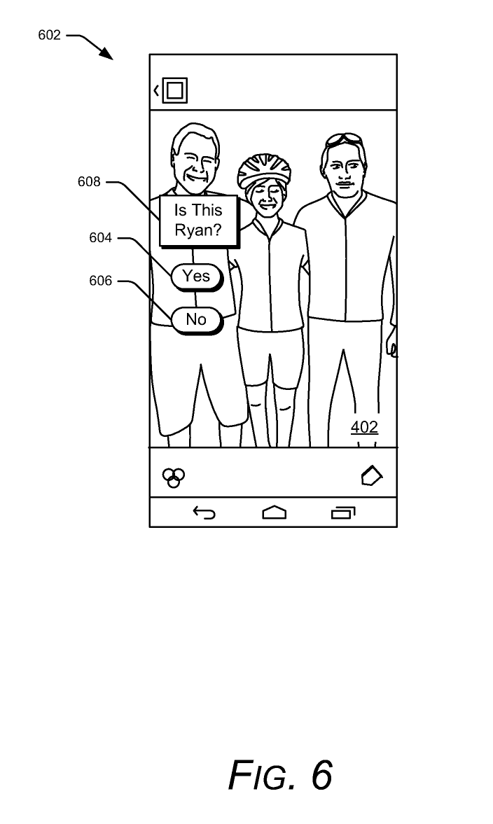

Assume, for this example, that the threshold is 95% to share media without an explicit selection. In such a case sharing module 112 can present a user interface asking for an explicit selection to share, this is illustrated in FIG. 6 with a recognition confirmation interface 602 in which a user may select to confirm a recognition. Here only one of the four recognitions is shown and with quick-and-easy selection enabled, namely a “Yes” confirmation control 604 to select to confirm that the face recognized is Ryan, a “No” control 606 to select that the face recognized is not Ryan, and the text asking for confirmation at query window 608. For confidences exceeding the threshold, sharing module 112 may instead automatically share without user selection or interaction, such as to share photo 402 with an entity having an interest in Mark or Bella or bicycling (based on recognition of helmet 508 of FIG. 5).

At 306, an entity having an interest in a person or object is determined. An interest can be determined based on a history of sharing visual media (e.g., captured prior to newly captured visual media) having a recognized person or object, as noted above. Other manners can be used, such as a prior explicit selection to have visual media shared, such as selecting visual media that has a recognized grandchild to be automatically shared with a grandmother.

Still other manners can be used, such as based on an indication being received from the entity through near-field communication or a personal-area network from a mobile device associated with the entity. Assume, for example, that two kids, Calvin and John, are at a park, have recently met, and are having great fun playing together. Assume also that each kid has a parent at the park watching them—Calvin's Dad and John's Mom. Assume further that one of the parents, Calvin'Dad, takes pictures of both kids—both Calvin and John. John's Mom can ask for the photo of both of the kids—and, with a simple tap of the two parent's phones together (NFC) or a PAN communication (e.g., prompting a user interface to select the interest and share), John's Mom can be made an entity 116 having an interest association 118 with her son John (person 122). Here we assume that the preferred communication 120 by which to share the photo is the same as the manner in which the indication is received, though that is not required. Responsive to receiving this indication of interest, the particular photo is shared by Calvin's Dad's smartphone (e.g., smartphone 102-3). With the interest, entity, and preferred communication established, additional photos can be shared automatically. As will be described in greater detail below, when visual media has the other parent's child (John) recognized in it, the other media can be shared, even automatically, from the first parent's device (Calvin's Dad) to the other person's device (John's Mom).

Note also that determining an entity in this manner may be used as an aid in recognizing persons or objects without user interaction. Continuing the example of the two parents and two kids, when John's Mom indicates her interest in John, share module 112 may note this for future facial recognition. As Calvin and John are the only two people in the photo, and Calvin is already known and recognized, John's face can be noted, whether with a name or without, as a person 122 with which the particular entity (John's Mom) has an interest. Then, when recognizing faces in other photos or videos taken by Calvin's Dad (especially that same day), a baseline for John can be known and used by facial recognition engine 132.

Returning to methods 300, at 310 the visual media is shared with the determined entity. This sharing can be through transmitter/transceiver 210, such as through a cellular network, the internet (e.g., through a social media network associated with the entity), NFC, PAN, and so forth.

For the example of Calvin and John, assume that Calvin's Dad takes a short video of the boys at 302. Sharing module 112, at 304, recognizes that John is in the video. At 306, sharing module 112 determines that John's Mom has an interest in John based on the prior-received indication. At 310, sharing module 112 shares, even automatically and without further interaction from Calvin's Dad, the video with John's Mom. Note how simple and easy this can make sharing visual media with interested entities. Instead of Calvin's Dad having to take down John's Mom's email address and so forth, later remember to send media to her, then enter her email, find the video, select the video, and so forth, the visual media is immediately sent to John's Mom.

Alternatively or additionally, methods 300 may receive a selection or de-selection of a determined entity prior to sharing the visual media at operation 310. This is shown generally at operation 312. In some cases this is performed through operations 314, 316, and 318.

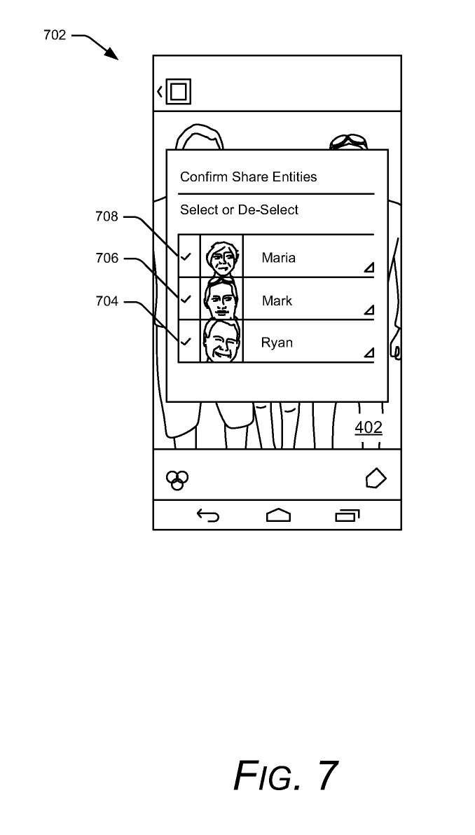

At 314, a user interface having a visual identifier for the determined entity is presented. This is illustrated in FIG. 7 with entity interface 702, and continues the example of the photo of the three friends biking from FIGS. 4-6. Here assume that sharing module 112 determines that, at operation 306, three entities 704, 706, and 708 have an interest association 118 for one or more recognized persons 122 or objects 124 of photo 402.

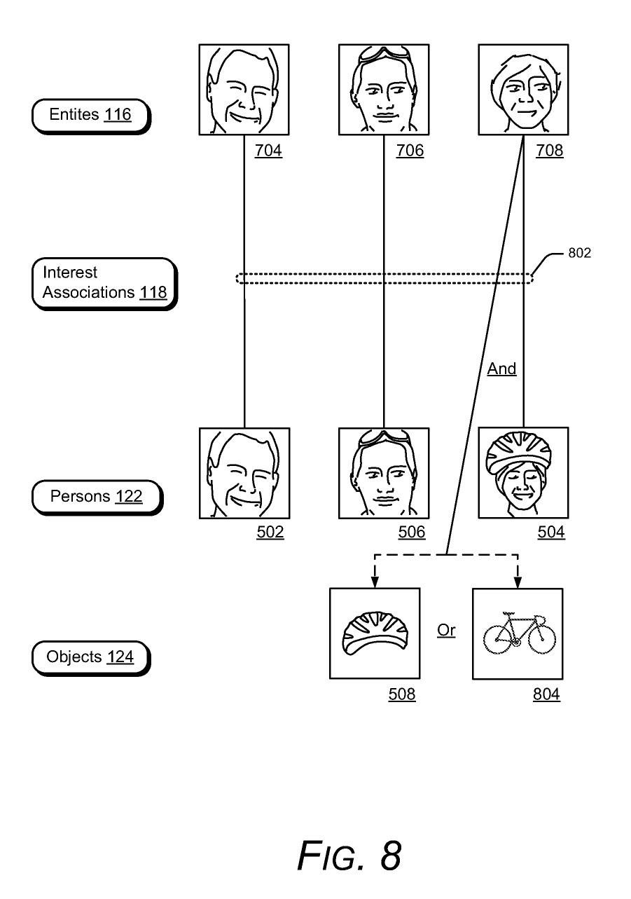

Interest associations 118 are illustrated for these entities in FIG. 8, which shows lines of interest 802 between entities 116, including 704, 706, and 708 of FIG. 7, persons 122, including Ryan, Mark, and Bella (502, 506, and 504 of FIG. 5), and bicycle helmet (508 of FIG. 5), as well as another object not shown in photo 402, bicycle object 804. Entity 704 is Ryan, who has an interest in receiving video media in which he is pictured. The same is true for entity 706 (Mark). Entity 708, however, has an interest not associated with herself, instead with both another person and an object. Assume here that entity 708, named Maria, is Bella's triathlon coach. Assume also that Maria has an interest in video media that have both Bella and a bicycle or bicycle helmet. In such a case Bella must be recognized and either a bicycle helmet or a bicycle, shown with the “and” and “or” respectively. Such interest associations can be established in the manners noted above, such as Bella having a history of sharing media with Maria in which she is pictured as well as a bicycle or bicycle helmet.

Returning to methods 300, at 316 selection through the visual identifier to select or de-select to share with the entity is enabled. Thus, Bella (assuming the method is operating on or through her mobile device), can de-select Maria, Mark, or Ryan to share photo 402. At 318, selection to select or deselect the determined entity is received. Here assume that Bella taps on Maria's visual identifier (her thumbnail) thereby de-selecting to share picture 402 to Maria. Responsive to this selection, de-selection, or simply to accept the determined entities as presented, sharing module 312 shares the visual media.

Note that entities, while described as persons, need not be. Thus, an entity may be an album or database having an interest association with persons and objects. Assume, for example, that Bella selects that any visual media having a bicycle or helmet be automatically shared with a database, such as her triathlon team's shared database. Bella may select that visual media having similar objects be shared with a databases, e.g., her photos and videos having same or similar objects or types of objects be compiled in the database. Thus, Bella's media that includes flowers can automatically be stored in a flower album or media of herself in a self-titled album.

Example Device-to-Device Sharing

As noted in part above, the apparatuses and techniques enable device-to-device sharing of visual media. This is but one example of the many ways in which visual media can be shared.

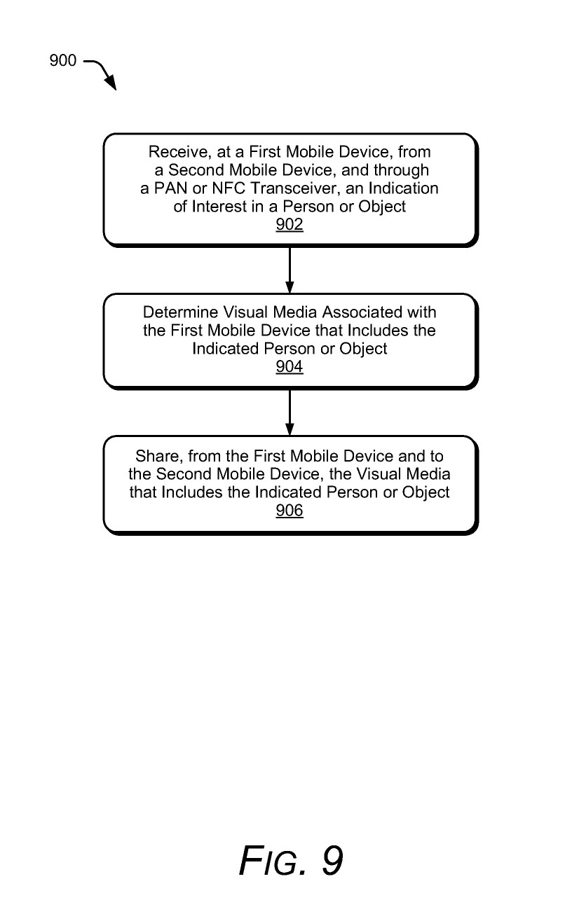

FIG. 9 illustrates example methods 900 for device-to-device sharing of visual media responsive to receiving an indication of interest through a personal area network (PAN) or near-field communication (NFC) communication.

At 902, an indication of interest in a person or object is received. This indication can be received at a first mobile device and from a second mobile device, such as through NFC or PAN communication. Examples of an indication received through these communications are set forth above, such as through tapping two mobile devices together.

At 904, visual media associated with the first mobile device that includes the indicated person or object is determined. This can be performed by sharing module 112 as noted above, such as to determine, by selection or process of elimination, a person or object of interest to a person associated with a mobile device from which the indication is received. Thus, John's Mom indicates an interest in a photo just taken of Calvin and John by Calvin's Dad and sharing module 112 determines that the person of interest is John based on Calvin having been recognized previously and known to Calvin s Dad's facial recognition engine 132 and sharing module 112. Or, for example, sharing module 112 may determine that a person associated with the second mobile device is both the entity and the person interest (e.g., Mark taps Mark's phone with Bella's phone to receive media that has Mark in it).

At 906, the visual media that includes the indicated person or object is shared with the second mobile device by the first mobile device. Concluding the above example, Calvin's Dad's smartphone shares the video of Calvin and John with John's Mom. Note also that other, later-taken or prior-captured visual media may also be shared, either automatically or responsive to selection.

Example Device

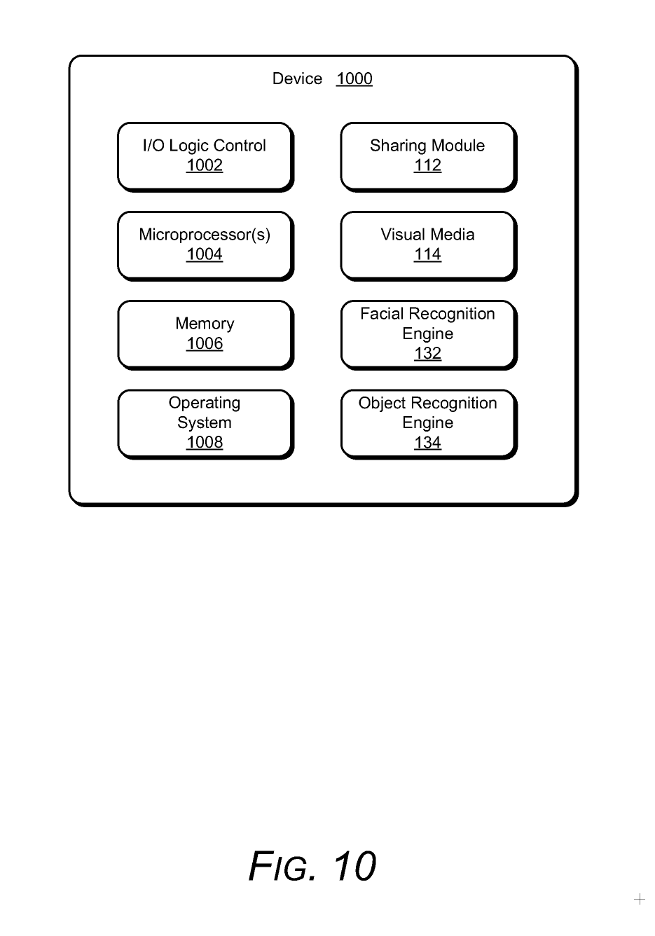

FIG. 10 illustrates various components of an example device 1000 including sharing module 112 as well as including or having access to other components of FIGS. 1 and 2. These components can implemented in hardware, firmware, and/or software and as described with reference to any of the previous FIGS. 1-9.

Example device 1000 can be implemented in a fixed or mobile device being one or a combination of a media device, desktop computing device, television set-top box, video processing and/or rendering device, appliance device (e.g., a closed-and-sealed computing resource, such as some digital video recorders or global-positioning-satellite devices), gaming device, electronic device, vehicle, workstation, laptop computer, tablet computer, smartphone, video camera, camera, computing watch, computing ring, computing spectacles, and netbook.

Example device 1000 can be integrated with electronic circuitry, a microprocessor, memory, input-output (I/O) logic control, communication interfaces and components, other hardware, firmware, and/or software needed to run an entire device. Example device 1000 can also include an integrated data bus (not shown) that couples the various components of the computing device for data communication between the components.

Example device 1000 includes various components such as an input-output (I/O) logic control 1002 (e.g., to include electronic circuitry) and microprocessor(s) 1004 (e.g., microcontroller or digital signal, processor). Example device 1000 also includes a memory 1006, which can be any type of random, access memory (RAM), a low-latency nonvolatile memory (e.g., flash memory), read only memory (ROM), and/or other suitable electronic data storage. Memory 1006 includes or has access to sharing module 112, visual media 114, facial recognition engine 132, and/or object recognition engine 134. Sharing module 112 is capable of performing one more actions described for the techniques, though other components may also be included.

Example device 1000 can also include various firmware and/or software, such as an operating system 1008, which, along with other components, can be computer-executable instructions maintained by memory 1006 and executed by microprocessor 1004. Example device 1000 can also include other various communication interfaces and components, wireless LAN (WLAN) or wireless PAN (WPAN) components, other hardware, firmware, and/or software.

Other examples capabilities and functions of these entities are described with reference to descriptions and figures above. These entities, either independently or in combination with other modules or entities, can be implemented as computer-executable instructions maintained by memory 1006 and executed by microprocessor 1004 to implement various embodiments and/or features described herein.

Alternatively or additionally, any or all of these components can be implemented as hardware, firmware, fixed logic circuitry, or any combination thereof that is implemented in connection with the I/O logic control 1002 and/or other signal processing and control circuits of example device 1000. Furthermore, some of these components may act separate from device 1000, such as when remote (e.g., cloud-based) services perform one or more operations for sharing module 112. For example, photo and video are not required to all be in one location, some may be on a user's smartphone, some on a server, some downloaded to another device (e.g., a laptop or desktop). Further, some images may be taken by a device, indexed, and then stored remotely, such as to save memory resources on the device.

### CONCLUSION

Although sharing visual media have been described in language specific to structural features and/or methodological acts, the appended claims is not necessarily limited to the specific features or acts described. Rather, the specific features and acts are disclosed as example forms of implementing techniques and apparatuses for sharing visual media.

What is claimed is:

1. A mobile computing device comprising:
a visual-media capture device;
a transmitter or transceiver;
one or more computer processors; and
one or more computer-readable storage media having instructions stored thereon, the instructions, responsive to execution by the one or more computer processors, performing operations comprising:
capturing visual media at the mobile computing device and through the visual-media capture device;
recognizing a person or object in the visual media;
determining an entity having interest in the recognized person or object; and
sharing, through the transmitter or transceiver, the visual media with the determined entity.

2. The mobile computing device of claim 1, wherein the operations of recognizing the person or object, determining the entity, and sharing the visual media are performed automatically and without user interaction.

3. The mobile computing device of claim 1, wherein recognizing the person or object recognizes the person through operation of a facial recognition engine.

4. The mobile computing device of claim 3, wherein sharing the visual media with the determined entity is responsive to a high confidence in recognizing the person.

5. The mobile computing device of claim 3, the operations further comprising, responsive to the operation of the facial recognition engine recognizing the person at a less-than high confidence, presenting a user interface enabling selection to confirm an identity of the recognized person prior to sharing the visual media with the determined entity and wherein sharing the visual media is responsive to confirmation of the identity of the recognized person.

6. The mobile computing device of claim 1, wherein recognizing the person or object recognizes an object through operation of an object recognition engine.

7. The mobile computing device of claim 6, wherein sharing the visual media with the determined entity shares the visual media with an album or database of visual media having the recognized object or a same type of object as the recognized object.

8. The mobile computing device of claim 1, wherein determining the entity having interest in the recognized person or object is based on a history of explicit selected sharing of other visual medias captured at the mobile device that also include the recognized person.

9. The mobile computing device of claim 1, wherein determining the entity having interest in the recognized person or object is based on an explicit selection through the mobile computing device to automatically share visual media having the recognized person or object with the entity.

10. The mobile computing device of claim 1, wherein determining the entity having interest in the recognized person is based on an indication received from the entity through near-field communication from a mobile device associated with the entity.

11. The mobile computing device of claim 1, wherein the recognized person or object is a person and the entity is not the recognized person.

12. The mobile computing device of claim 1, wherein sharing the visual media is responsive to determining a preferred communication for the entity, and sharing the visual media is through the preferred communication.

13. The mobile computing device of claim 1, the operations further comprising, prior to sharing the visual media, receiving selection or de-selection of the determined entity.

14. The mobile computing device of claim 13, wherein receiving selection or de-selection of the determined entity comprises:
presenting a user interface having a visual identifier for the determined entity;
enabling selection through the visual identifier to select or de-select to share with the determined entity; and
receiving selection to select or deselect the determined entity.

15. One or more computer-readable storage media having instructions stored thereon that, responsive to execution by one or more computer processors, performs operations comprising:
receiving, at a first mobile device, from a second mobile device, and through a personal area network (PAN) or near-field communication (NFC), an indication of interest in a person or object;
determining visual media associated with the first mobile device that includes the indicated person or object; and
sharing, from the first mobile device to the second mobile device, the visual media that includes the indicated person or object.

16. The media of claim 15, wherein sharing the visual media is through the PAN or NFC.

17. The media of claim 15, wherein determining the visual media that includes the indicated person or object recognizes the person through operation of a facial recognition engine.

18. The media of claim 15, wherein receiving the indication of interest in the person or object does not specify the person or object and further comprising determining the person or object to be a person associated with the second mobile device.

19. A method comprising:
determining an entity having an interest in a person, the determining based on a history of sharing, with the entity, prior-captured visual medias having the person;
recognizing the person in a newly captured visual media, a probability of the recognition exceeding a threshold; and
automatically sharing, without selection or user interaction, the newly captured visual media with the determined entity.

20. The method of claim 19, wherein the automatically sharing is through a social media network associated with the entity.
